(19) United States
(12) Patent Application Publication
(10) Pub. No.: US 2017/0223983 A1
(43) Pub. Date: Aug. 10, 2017

(54) IMPROVED CHEWING GUM COMPOSITIONS AND METHODS OF MANUFACTURE THEREFOR

(71) Applicant: Intercontinental Great Brands LLC, East Hanover, NJ (US)

(72) Inventors: Joseph Raymond Carlise, East Hanover, NJ (US); Demetrius Torino McCormick, East Hanover, NJ (US); Simman Wong, East Hanover, NJ (US)

(21) Appl. No.: 15/503,572

(22) PCT Filed: Aug. 12, 2015
(86) PCT No.: PCT/IB2015/001936

§ 371 Date: Feb. 13, 2017

Related U.S. Application Data
(60) Provisional application No. 62/037,286, filed on Aug. 14, 2014.

(51) Int. Cl. A23G 4/08

(52) U.S. Cl. CPC A23G 4/08; A23V 2002/00

(57) ABSTRACT

Provided herein are gum compositions comprising: at least one emulsifier having a relative weighted average hydrophilic-lipophilic balance (RWA HLB) within a range of 3.9-12 and having an absolute weighted average HLB (AWA HLB) within a range of 0.10-0.25.

### FIELD

This disclosure generally relates to chewing gum compositions and more particularly to chewing gum compositions that include certain emulsifier(s) in specified amounts such that their inclusion falls within defined parameters of: relative weighted average hydrophilic-lipophilic balance (RWA HLB) and absolute weighted average HLB (AWA HLB). Consequently, chewing gum compositions thus formed can have at least one of numerous advantages. In addition to observed advantages, improved chew characteristics can be confirmed by physical measurements such as moisture absorption, hardness and/or surface tension.

### BACKGROUND

Chewing gums available today generally contain a water-insoluble gum base, sweeteners, natural or artificial flavors, and a variety of additional components tailored to provide specific release characteristics. For example, some chewing gums can include plasticizers or softeners to improve consistency during chew. Other chewing gums, for instance, can include physiological cooling agents to provide a cooling sensation upon consumption by the user. Oral delivery of actives, such as flavors, sweeteners, sensates and therapeutic agents, for their intended purpose, is one of the main objectives of current chewing gum compositions.

Various formulations and gum compositions have been proposed and aimed at improving desirable properties. For example, U.S. Pat. No. 5,858,391 relates to formulations or systems intended to coat and protect the oral cavity and the esophagus membranes and/or gastrointestinal tract against high acidity from various conditions while allowing for an active drug contained in the formulation to be released using controlled rates. While confectionary and chewing compositions containing the emulsions are mentioned in U.S. Pat. No. 5,858,391, the reference contemplates the use of an active pharmaceutical composition dispersed a water-in-oil emulsion system having at least two phases in which one phase includes about 75-99% by volume of an internal hydrophilic phase and the other phase includes about 1-25% by volume of an external hydrophobic phase. The external hydrophobic phase is said to be comprised of at least two components, with one of the components being about 3-97% of a hydrophobic oil and the other component being about 3-97% of an emulsifier having a HLB value of less than about 10.

Another approach aimed at providing improved attributes of chewing gum compositions is set forth in U.S. Pat. No. 5,487,902, which relates to chewing gum compositions to allow for accelerated, controlled release of active agents. More particularly, the chewing gum base includes a resin component containing at least 25 weight % of a particular resin. The resins used are of importance to compositions disclosed in U.S. Pat. No. 5,487,902 and are said to be necessary to forming part of a chewing gum base to obtain the right consistency and as a solubilizer for the elastomers of the chewing gum base. The accelerated release of the active agent is provided for by adding at least one solubilizer having an HLB of 14-20 in a quantity of 0.1-10 weight % to the chewing gum composition.

There is a need, however, for new chewing gum compositions which provide for a chewing gum that looks the same as conventional chewing gum, while, after chewing, has at least one of the following advantages: increased moisture uptake, increased bolus size, increased cooling and/or flavor perception, higher pellet core hardness while maintaining gum softness, increased mouthwatering, increased softness during chew, increased smoothness perception during chew, less drying, and/or being less squeaky relative to conventional chewing gum.

### BRIEF DESCRIPTION OF THE DRAWINGS

Referring now to the FIGURES, which are exemplary embodiments, and wherein the like elements are numbered alike.

FIG. 1 illustrates moisture profiles of gum during mastication in accordance with Comparative Example 1 (C1), Example 2 and other available chewing gums.

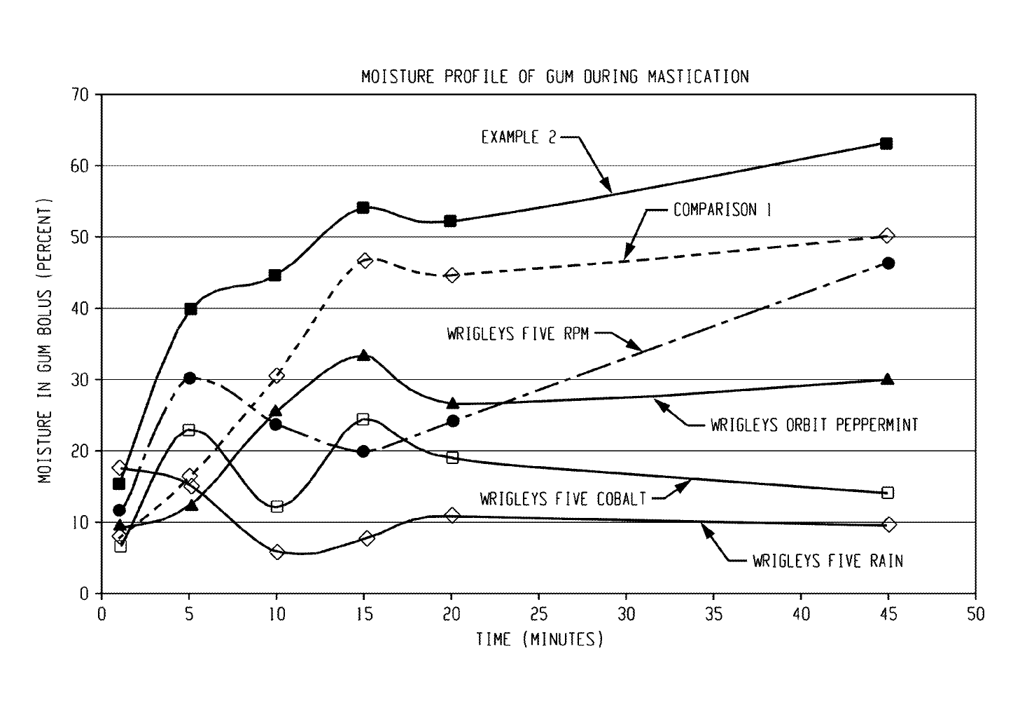

### SUMMARY

Disclosed herein are gum compositions comprising: at least one emulsifier having a relative weighted average hydrophilic-lipophilic balance (RWA HLB) within a range of 3.9-12 and having an absolute weighted average HLB (AWA HLB) within a range of 0.10-0.25.

In another aspect, a gum composition is provided and comprises: a mixture of at least a first emulsifier and at least a second emulsifier, the mixture having a relative weighted average hydrophilic-lipophilic balance (RWA HLB) within a range of 3.9-12 and having an absolute weighted average HLB (AWA HLB) within a range of 0.10-0.25.

In yet another aspect provided herein is a method of making a gum composition, comprising: providing at least one emulsifier having a relative weighted average hydrophilic-lipophilic balance (RWA HLB) within a range of 3.9-12 and having an absolute weighted average HLB (AWA HLB) within a range of 0.10-0.25 in a gum composition.

The above described and other features are exemplified by the following FIGURES and detailed description.

### DETAILED DESCRIPTION

Disclosed herein are chewing gum compositions that include certain emulsifier(s) in specified amounts such that their inclusion falls within defined parameters of: relative weighted average hydrophilic-lipophilic balance (RWA HLB) and absolute weighted average HLB (AWA HLB). Consequently, chewing gum compositions thus formed can have at least one of numerous advantages. In addition to observed advantages, improved chew characteristics can be confirmed by physical parameters such as moisture absorption, hardness and/or surface tension.

For example, high moisture chewing gum bolus can be obtained through the addition of emulsifier(s) having certain HLB (hydrophilic-lipophilic balance) characteristics and included in amounts that define certain parameters useful for improving gum formulations. More particularly, disclosed herein are the use of certain parameters based on the characteristics of the emulsifier(s) and the amounts that the emulsifier(s) are present in the gum composition such that formulation of products and compositions can be characterized by at least one or more of the following advantages: increased moisture uptake, increased bolus size, increased cooling and/or flavor perception, higher pellet core hardness while maintaining gum softness, increased mouthwatering, increased softness during chew, increased smoothness perception during chew, less drying, and/or less squeaky relative to conventional chewing gum can be obtained. In addition, the gum compositions provided herein can be further characterized by a normal or typical gum appearance in the unchewed state, while, after chewing, have at least one of the above mentioned advantages.

Chewing gum compositions thus provided herein can be characterized by desirable product attributes. For example, product attributes such as moisture absorption (mass or volume increase during chew), surface tension using water (or saliva equivalent) on gum surface, coefficient of friction, extensibility, textural analyzer (hardness), shelf life and/or gum stability and surfactant residence time in the gum can be achieved by the compositions disclosed herein.

More particularly, it is expected that increased moisture uptake demonstrated through surface tension tests can be exhibited by the compositions disclosed herein. This is expected as compositions having emulsifiers having RWA HLB and AWA HLB values as defined herein will drive more moisture uptake by gum bolus and should make the gum (and its surface) more hydrophilic and give a lower contact angle when water is applied to the surface of chewed gum. In addition, moisture absorption or change in mass during chew is expected as the compositions having emulsifiers having RWA HLB and AWA HLB values as defined herein are expected to drive more moisture uptake by gum bolus and increase the bolus mass relative to conventional gum. Any loss of mass through “chew out” of water soluble gum components is expected to be similar to conventional gum.

In addition, increased flavor and/or cooling perception based on analytical flavor release is expected as more saliva will be driven into the bolus, more flavor/cooler will be released. It is therefore expected that analytical tests should show an increase in % flavor release relative to conventional gum.

Higher pellet core hardness while maintaining gum softness (or maintaining pellet core hardness and increasing gum softness) as demonstrated through extensibility, texture analyzer or hardness tests are expected to show that unchewed gums should show no significant difference in extensibility and hardness relative to conventional gum. Due to high moisture uptake during the chew, compositions having emulsifiers having RWA HLB and AWA HLB values as defined herein should show greater extensibility and be softer than conventional chewed samples of gum. Increased softness during chew should increase with duration of chew, until equilibrium is reached.

Increased mouthwatering as demonstrated for example through moisture absorption or change in mass during chew is expected as compositions having emulsifiers having RWA HLB and AWA HLB values as defined herein will drive moisture absorption from saliva, stimulating generation of more saliva and mouthwatering effects.

Increased smoothness perception during chew as demonstrated for example by coefficient of friction and/or surface tension are expected as compositions having emulsifiers having RWA HLB and AWA HLB values as defined herein increase the moisture content of the gum as it is chewed; the gum (and its surface) become more hydrophilic and is therefore perceived in the aqueous, mouth surfaces as more smooth than conventional gums. Lower coefficients of friction and lower contact angles indicate increase in hydrophilicity than conventional or control gum.

Gum that is perceived as less drying, as evidenced by moisture absorption, are expected as the higher moisture uptake can yield a gum that is perceived as less dry than conventional gum. In addition, a gum that is perceived as less squeaky can be provided as demonstrated by coefficient of friction and surface tension. This can be expected as compositions having emulsifiers having RWA HLB and AWA HLB values as defined herein increase the moisture content of the gum as it is chewed; the gum (and its surface) become more hydrophilic and therefor slides more easily over aqueous tooth surfaces. Lower coefficients of friction and lower contact angles indicate an increase in hydrophilicity over conventional or control gum.

It has been discovered that at least some of the above chewed product attributes and/or advantages for chewing gum compositions can be achieved by providing formulations comprising: at least one emulsifier having a relative weighted average hydrophilic-lipophilic balance (RWA HLB) within a range of 3.9-12 and having an absolute weighted average HLB (AWA HLB) within a range of 0.10-0.25. Gum made with RWA HLB and AWA HLB below these ranges exhibit the properties of conventional gum. Gum made with RWA HLB and AWA HLB significantly above these ranges shows a loss of structural integrity and can break apart.

### Definitions

As used herein, “relative weighted average hydrophilic-lipophilic balance” (RWA HLB) refers a blended average HLB of the emulsifier(s) in a composition and thus refers to the emulsifiers themselves rather than the formulation or environment in which they are used. As used herein, the RWA HLB is determined by equation (1) as follows:

RWA HLB=[wt % emul₁*HLB emul₁)+(wt % emul₂*HLB emul₂)+(wt % emul₃*HLB emul₃)+ . . . +(wt % emulₙ*HLB emulₙ)]/[wt % all emulsifiers combined]; (1)
wherein
RWA=relative weight average;
HLB=hydrophilic-lipophilic balance;
wt %=weight percent in the overall gum composition formulation
emul=emulsifier;
emul₁=emulsifier #1;
emul₂=emulsifier #2;
emul₃=emulsifier #3; and
emulₙ=refers to continuing summation until all emulsifiers in the composition have been included.

As used herein, “absolute weighted average hydrophilic-lipophilic balance” (AWA HLB) takes into account the concentration of the emulsifiers in the composition or system, and thus reflects the degree to which the composition or system has been treated. Because the AWA HLB is an absolute quantity, the overall degree to which the composition or system has been emulsified, independent of emulsifier choice, blend ratios and the like can be considered. As used herein, the AWA HLB is determined by equation (2) as follows:

AWA HLB=[(wt % emul₁*HLB emul₁)+(wt % emul₂*HLB emul₂)+(wt % emul₃*HLB emul₃)+ . . . (wt % emulₙ*HLB emulₙ)]: (2)
wherein
AWA=absolute weight average;
HLB=hydrophilic-lipophilic balance;
wt %=weight percent in the overall gum composition formulation
emul=emulsifier;
emul₁=emulsifier #1;
emul₂=emulsifier #2;
emul3=emulsifier #3; and
emulₙ=refers to continuing summation until all emulsifiers in the composition have been included.

As used herein, “moisture absorption” refers to the amount of water remaining within the chewing gum bolus after defined mechanical chew period(s) as determined by mechanical chew on a brabender mixer in the presence of water, weighing the sample, drying the sample and reweighing to determine the mass of the lost water.

As used herein, “surface tension” refers to the contact angle of water on the surface of a subject chewing gum as determined by applying a drop of water onto the surface of chewing gum and measuring the angle at which the droplet contacts the surface.

As used herein, “hardness” refers to the force required to drive a probe through a thickness of chew gum as determined by measuring the maximum force required to drive a probe through a piece of chewing gum through a portion of the total gum thickness.

As used herein, “emulsifier” or “emulsifiers” refer(s) to an agent that promotes the formation and/or stabilization of an emulsion and has a HLB value. Materials that are and/or have been used as softeners, plasticizers, resins or the like that do not have a HLB value are excluded from the definition of “emulsifier(s)” herein. While not to be construed as limiting, examples of emulsifiers include one or more of: polyglycerol esters of fatty acids (having for example a HLB in the range of 7-12), 2 mole ethoxylate of linear C12-C14 alcohol (such as SURFONIC® L24-2 commercially available from Huntsman); 3 mole ethoxylate of linear C12-C14 alcohol (such as SURFONIC® L24-3 commercially available from Huntsman); 4 mole ethoxylate of linear C12-C14 alcohol (such as SURFONIC® L24-4 commercially available from Huntsman); 5 mole ethoxylate of linear C12-C14 alcohol (such as SURFONIC® L24-5 commercially available from Huntsman); 7 mole ethoxylate of linear C12-C14 alcohol (such as SURFONIC® L24-7 commercially available from Huntsman); 9 mole ethoxylate of linear C12-C14 alcohol (such as SURFONIC® L24-9 commercially available from Huntsman); and 12 mole ethoxylate of linear C12-C14 alcohol (such as SURFONIC® L24-12 commercially available from Huntsman); lecithin; glyceryl monostearate; acetylated monoglycerides; and combinations thereof. Additional emulsifiers can include one or more of the following: oleic acid (having for example a HLB of about 1); acetylated monoglycerides (having for example a HLB of about 1.5); sorbitan trioleate (having for example a HLB of about 1.8); glycerol dioleate (having for example a HLB of about 1.8); sorbitan tristearate (having for example a HLB of about 2.1); propylene glycol monostearate (having for example a HLB of about 3.4); glycerol monooleate (having for example a HLB of about 3.4); glycerol monostearate (having for example a HLB of about 3.8); acetylated monoglycerides (stearate) (having for example a HLB of about 3.8); sorbitan monooleate (having for example a HLB of about 4.3); propylene glycol monolaurate (having for example a HLB of about 4.5); sorbitan monostearate (having for example a HLB of about 4.7); calcium stearoxyl-2-lactylate (having for example a HLB of about 5.1); glycerol monolaurate (having for example a HLB of about 5.2); sorbitan monopalmitate (having for example a HLB of about 6.7); lecithin (having for example a HLB of about 4); diacetylated tartaric acid esters of monoglycerides (having for example a HLB of about 8); sodium stearoyl lactylate (having for example a HLB of about 8.3); sorbitan monolaurate (having for example a HLB of about 8.6); polyoxyethylene (20) sorbitan tristearate (having for example a HLB of about 10.5); polyoxyethylene (20) sorbitan trioleate (having for example a HLB of about 11); polyoxyethylene (20) sorbitan monostearate (having for example a HLB of about 14.9); sucrose monolaurate (having for example a HLB of about 15); polyoxyethylene (20) sorbitan monooleate (having for example a HLB of about 15); polyoxyethylene (20) sorbitan monopalmitate (having for example a HLB of about 15.6); and combinations thereof. Further, an emulsifier can include one or more of: glyceryl monostearate, lecithin, a fatty acid monoglyceride, a diglyceride, propylene glycol monostearate, and combinations of any of the foregoing. The emulsifier may comprise sugar esters, polyglycerol fatty acid esters, polyglycerol polyricinoleate (PGPR), polysorbates (polyoxyethylene sorbitan esters), monoglycerides, sodium stearoyl lactylate (SSL) and combinations of any of the foregoing. Other exemplary emulsifiers can include one or more of: distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, the poly(oxyethylene) sorbitan fatty acid esters sold under the trade name TWEEN, the sorbitan fatty acid esters sold under the trade name SPAN, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, and combinations thereof.

As used herein, the terms “gum,” “chewing gum,” “gum composition” and “chewing gum composition” are used interchangeably and are meant to include any “chewing gum composition”. Coating(s), shell(s), particulates within the gum of larger than 400 microns, center-fill(s) and/or cores made from non-gum materials and/or dusting particle(s) are excluded from the definition of “chewing gum composition” for purposes of determining RWA HLB and AWA HLB. With regard to chewing gum compositions herein, such compositions contain a gum base, a flavor enhancing composition, at least one emulsifier and various additives. In addition to the emulsifier(s), the chewing gum composition comprises a gum base, bulk sweeteners, high intensity sweeteners, flavorants, coloring agents, sensates, and any other optional additives, including throat-soothing agents, spices, tooth-whitening agents, breath-freshening agents, vitamins, minerals, caffeine, drugs (e.g., medications, herbs, and nutritional supplements), oral care products, and combinations thereof.

Generally, the chewing gum composition comprises a water insoluble gum base portion and a water-soluble bulk portion. The gum base can vary greatly depending upon various factors such as the type of base desired, the consistency of gum desired, and the other components used in the composition to make the final chewing gum product. The gum base can be any water-insoluble gum base known in the art, and includes those gum bases utilized for chewing gums and bubble gums. Illustrative examples of suitable polymers in gum bases include both natural and synthetic elastomers and rubbers, for example, substances of vegetable origin such as chicle, crown gum, nispero, rosidinha, jelutong, perillo, niger gutta, tunu, balata, gutta-percha, lechi-capsi, sorva, gutta kay, and the like, and combinations thereof.

The gum compositions disclosed herein can be uncoated, and be in the form of slabs, sticks, pellets, balls, and the like. While gum compositions as disclosed herein can further be coated, such coating is not included in the definition of the gum composition, as noted above, and is thus excluded from RWA HLB and AWA HLB. The composition of the different forms of the gum compositions will be similar but can vary with regard to the ratio of the ingredients. For example, coated gum compositions can contain a lower percentage of softeners. Pellets and balls can have a chewing gum core, which has been coated with either a sugar solution or a sugarless solution to create the hard shell. Slabs and sticks are usually formulated to be softer in texture than the chewing gum core. In some cases, a hydroxy fatty acid salt or other surfactant actives can have a softening effect on the gum base. In order to adjust for any potential undesirable softening effect that the surfactant actives can have on the gum base, it can be beneficial to formulate a slab or stick gum having a firmer texture than usual (i.e., use less conventional softener than is typically employed).

Center-filled gum can be another common gum form and the gum portion can have a similar composition and mode of manufacture to that described herein. However, the center-fill is typically an aqueous liquid or gel, which is injected into the center of the gum during processing. The center-filled gum can also be optionally coated and can be prepared in various forms, such as in the form of a lollipop. As noted above, however, center-fill and/or coating(s) are not included in the definition of the gum composition and are thus excluded from RWA HLB and AWA HLB.

Synthetic elastomers for the gum base include high- and low-molecular weight elastomers. Useful high molecular weight elastomers include butadiene-styrene copolymers, polyisoprene, polyisobutylene, isobutylene-isoprene copolymers, polyethylene, combinations thereof, and the like. Useful low-molecular weight elastomers include polybutene, polybutadiene, polyisobutylene, and combinations thereof. Suitable gum bases can also include vinyl polymeric elastomers such as poly(vinyl acetate) (PVA), polyethylene, vinyl copolymeric elastomers such as copolymers of vinyl acetate and vinyl laurate, copolymers of vinyl acetate and vinyl stearate, copolymers of ethylene and vinyl acetate, poly(vinyl alcohol) and combinations thereof. When utilized, the number average molecular weight of the vinyl polymers can range about 3,000 to about 94,000. Vinyl polymers such as poly(vinyl alcohol) and poly(vinyl acetate) (when employed in the gum base, as distinguished from the encapsulated food-grade acid) can have a number average molecular weight of about 8,000 to about 65,000. Furthermore, any combination of the aforementioned high- and low-molecular weight, natural and synthetic elastomers, and rubbers can be used as a gum base.

The amount of gum base employed will vary greatly depending upon various factors such as the type of base used, the consistency of the gum desired, and the other components used in the composition to make the final chewing gum product. In general, the gum base will be present in an amount of about 5 to about 94 weight percent of the final chewing gum composition. In some embodiments, the gum base amount is about 15 to about 45 weight percent, specifically about 15 to about 35 weight percent, more specifically about 20 to about 30 weight percent, based upon the total weight of the chewing gum product.

The gum base composition can contain conventional elastomer plasticizers to aid in softening the elastomer base component, for example terpene resins such as polymers derived from alpha-pinene, beta-pinene, and/or d-limonene; methyl, glycerol or pentaerythritol esters of rosins or modified rosins and gums, such as hydrogenated, dimerized or polymerized rosins, or combinations comprising at least one of the foregoing resins; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like. Any combination of the foregoing elastomer plasticizers can be used to soften or adjust the tackiness of the elastomer base component. The elastomer plasticizer can be used in amounts of about 5 to about 75 weight percent of the gum base, specifically about 45 to about 70 weight percent of the gum base.

Suitable plasticizers and softeners include compounds that are emulsifiers with HLB values as well as non-emulsifiers without HLB values. Other suitable softeners include waxes. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, cocoa butter, and the like can also be incorporated into the gum base to obtain a variety of desirable textures and consistency properties.

Conventional additives can be included in the gum base in effective amounts such as plasticizers or softeners to provide a variety of desirable textures and consistency properties. Because of the low molecular weight of these components, the plasticizers and softeners are able to penetrate the fundamental structure of the gum base making it plastic and less viscous. These additives are generally used in amounts of up to about 30 weight percent of the gum base, specifically about 3 to about 20 weight percent of the gum base.

When a wax is present in the gum base, it softens the polymeric elastomer mixture and improves the elasticity of the gum base. The waxes employed can have a melting point below about 60 degrees Celsius, and preferably between about 45 and about 55 degrees Celsius. The low melting wax can be a paraffin wax. The wax can be present in the gum base in an amount about 6 to about 10 weight percent, and preferably about 7 to about 9.5 weight percent, based on the total weight of the gum base.

In addition to the low melting point waxes, waxes having a higher melting point can be used in the gum base in amounts up to about 5 weight percent of the gum base. Such high melting waxes include beeswax, vegetable wax, rice bran wax, candelilla wax, carnuba wax, polyethylene wax, microcrystalline wax, most petroleum waxes, and the like, and mixtures thereof.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and the like, which can serve as fillers and textural agents. These fillers or adjuvants can be used in the gum base in various amounts. Specifically the amount of filler, when used, will be present in an amount of greater than about 15 to about 40 weight percent, specifically about 20 to about 30 weight percent, based on the weight of the gum base.

In addition to a water insoluble gum base portion, a typical chewing gum composition includes a water soluble bulk portion and one or more flavoring agents. In another embodiment, the active ingredient is present in a water soluble bulk portion of the chewing gum composition. The water soluble portion can include bulk sweeteners, high-intensity sweeteners, flavoring agents, softeners, emulsifiers, coloring agents, acidulants, fillers, antioxidants, and other conventional chewing gum additives that provide desired attributes. In some embodiments, the active ingredient has a water solubility of at least about 100 grams per liter at 25° C. and one atmosphere, specifically about 200 to about 1000 grams per liter at 25° C. and one atmosphere, and more specifically about 300 to about 800 grams per liter at 25° C. and one atmosphere. For example, citric acid has a water solubility of about 730 grams per liter at 25° C. and one atmosphere. And malic acid has an water solubility or about 588 grams per liter at 20° C. and one atmosphere. These and other conventional chewing gum additives known to one having ordinary skill in the art can also be incorporated into the gum base.

Also disclosed herein are methods for preparing the chewing gum compositions. The chewing gum compositions can be prepared using any standard techniques and equipment known to those skilled in the art. The apparatus useful in accordance with some methods used herein comprises mixing and heating apparatus well known in the chewing gum manufacturing arts, and therefore the selection of the specific apparatus will be apparent to the artisan.

The chewing gum composition can thus be formed using standard techniques and equipment. In one exemplary process, a gum base is heated to a temperature sufficiently high to soften the base without adversely effecting the physical and chemical make up of the base, which will vary depending upon the composition of the gum base used, and is readily determined by those skilled in the art without undue experimentation. For example, the gum base can be melted to about 60 to about 160 degrees Celsius, or melted to about 150 to about 175 degrees Celsius, for a period of time sufficient to render the base molten, for example, about thirty minutes, just prior to being admixed incrementally with the remaining ingredients of the base such as the plasticizer, fillers, the bulking agent or sweeteners, the softener and coloring agents to plasticize the blend as well as to modulate the hardness, viscoelasticity and formability of the base, and the flavor enhancing composition (as a concentrate with other additives or separately). One or more of the emulsifiers can be added to the gum base or later in the process. In addition or alternatively, one more of the emulsifiers can be combined and mixed with the gum base and the remaining emulsifiers can be subsequently combined and mixed with the other remaining ingredients. Mixing is continued until a uniform mixture of the gum composition is obtained. Thereafter the gum composition mixture can be formed into desirable gum shapes, i.e., stick, slab, pellet, ball, or the like. The sized chewing gum can be conditioned for about one day prior to packaging the chewing gum.

As mentioned above, it has been discovered that chewing gum compositions that include certain emulsifier(s) in specified amounts such that their inclusion falls within defined parameters of: relative weighted average hydrophilic-lipophilic balance (RWA HLB) and absolute weighted average HLB (AWA HLB) can have at least one of numerous advantages. It has been more specifically determined that chewing gum compositions having a RWA HLB) within a range of 3.9-12, for example within a range of 4-6, and having an absolute weighted average HLB (AWA HLB) within a range of 0.10-0.25, for example within a range of 0.13-0.18, can have one or more numerous advantages such as at least one or more of the following advantages: increased moisture uptake, increased bolus size, increased cooling and/or flavor perception, higher pellet core hardness while maintaining gum softness during chew, increased mouthwatering, increased softness during chew, increased smoothness perception during chew, less drying, and/or less squeaky relative to conventional chewing gum can be obtained. In addition, the gum compositions provided herein can be further characterized by a normal or typical gum appearance in the unchewed state.

The features and advantages are more fully shown by the following examples that are provided for purposes of illustration, and are not to be construed as limiting the invention in any way.

The foregoing and other embodiments are further illustrated by the following examples, which are not intended to limit the effective scope of the claims. All parts and percentages in the examples and throughout the specification and claims are by weight of the final composition unless otherwise specified.

### EXAMPLES

Comparative examples (noted herein as “C1”, “C2”, “C3”, “C4” and/or “C5”) and examples illustrating the aspects of the combined RWA and AWA parameters (noted herein as “Ex 1”, “Ex 2 “Ex 3” “Ex 4” “Ex 5” “Ex 6” “Ex 7”, “Ex 8”, “Ex 9”, “Ex 10”, “Ex 11”, “Ex 12” and/or “Ex 13”) disclosed herein were manufactured as follows and in accordance with the respective weight % s shown in Table 1. The emulsifiers and respective HLB values used in the comparative examples and the examples are set forth in Table 2 while the RWA HLB and AWA HLB values for the comparative examples and examples are set forth in Table 3.

In the comparative examples and the examples, the gum base and other ingredients were combined and mixed in a manner to sufficient blend the ingredients. More specifically, gum base was heated to a temperature sufficiently high to soften the base without adversely effecting the physical and chemical make up of the base and for a time sufficient to render the base molten. The gum base was then admixed incrementally with the remaining ingredients to plasticize the blend as well as to modulate the hardness, viscoelasticity and formability of the base, and any flavor enhancing composition. The emulsifiers were added to the gum base at various stages of the process (the time of addition was not expected to effect the final product). Mixing was continued until a uniform mixture of the gum composition was obtained. Thereafter the gum composition mixture was formed into pellets employing conventional techniques, e.g., extruded, rolled and cut into pellets.

TABLE 1
Table 1 (Amounts in Weight %)

| Ingredients | C1 | Ex 1 | Ex 2 | C2 | Ex 3 | Ex 4 | Ex 5 | Ex 6 | Ex 7 |
|---|---|---|---|---|---|---|---|---|---|
| Polyols | 54.72 | 53.97 | 53.87 | 53.25 | 53.25 | 53.25 | 53.25 | 53.25 | 53.25 |
| Softener | 8.50 | 8.50 | 8.50 | 8.50 | 8.50 | 8.50 | 8.50 | 8.50 | 8.50 |
| Glycerol Monostearate | 1.51 | 1.51 | 1.51 | 1.45 | 0.34 | 0.34 | 0.34 | 0.34 | 0.34 |
| Lecithin | 0.38 | 0.38 | 0.38 | 0.56 | 0.56 | 0.56 | 0.56 | 0.56 | 0.56 |
| Acetylated Monoglycerides | 0.50 | 0.50 | 0.50 | 0.50 | 0.50 | 0.50 | 0.50 | 0.50 | 0.50 |
| Polyglycerol Esters of Fatty Acids (HLB 7.5) | 0.00 | 0.75 | 0.00 | 0.00 | 0.00 | 0.00 | 0.00 | 0.00 | 0.00 |
| Polyglycerol Esters of Fatty Acids (HLB 11) | 0.00 | 0.00 | 0.85 | 0.00 | 0.00 | 0.00 | 0.00 | 0.00 | 0.00 |
| SURFONIC ® L24-2 | 0.00 | 0.00 | 0.00 | 0.00 | 1.11 | 0.00 | 0.00 | 0.00 | 0.00 |
| SURFONIC ® L24-3 | 0.00 | 0.00 | 0.00 | 0.00 | 0.00 | 1.11 | 0.00 | 0.00 | 0.00 |
| SURFONIC ® L24-4 | 0.00 | 0.00 | 0.00 | 0.00 | 0.00 | 0.00 | 1.11 | 0.00 | 0.00 |
| SURFONIC ® L24-5 | 0.00 | 0.00 | 0.00 | 0.00 | 0.00 | 0.00 | 0.00 | 1.11 | 0.00 |
| SURFONIC ® L24-7 | 0.00 | 0.00 | 0.00 | 0.00 | 0.00 | 0.00 | 0.00 | 0.00 | 1.11 |
| SURFONIC ® L24-9 | 0.00 | 0.00 | 0.00 | 0.00 | 0.00 | 0.00 | 0.00 | 0.00 | 0.00 |
| SURFONIC ® L24-12 | 0.00 | 0.00 | 0.00 | 0.00 | 0.00 | 0.00 | 0.00 | 0.00 | 0.00 |
| Other Gum Base ingredients | 27.36 | 27.36 | 27.36 | 28.71 | 28.71 | 28.71 | 28.71 | 28.71 | 28.71 |
| Flavor | 3.41 | 3.41 | 3.41 | 3.41 | 3.41 | 3.41 | 3.41 | 3.41 | 3.41 |
| Sweeteners (free and encapsulated) | 3.51 | 3.51 | 3.51 | 3.51 | 3.51 | 3.51 | 3.51 | 3.51 | 3.51 |
| Acids (free and encapsulated) | 0.00 | 0.00 | 0.00 | 0.00 | 0.00 | 0.00 | 0.00 | 0.00 | 0.00 |
| Coloring | 0.11 | 0.11 | 0.11 | 0.11 | 0.11 | 0.11 | 0.11 | 0.11 | 0.11 |
| Total (%) | 100.00 | 100.00 | 100.00 | 100.00 | 100.00 | 100.00 | 100.00 | 100.00 | 100.00 |
| Ingredients | Ex 8 | Ex 9 | C3 | Ex 10 | C4 | Ex 11 | C5 | Ex12 | Ex 13 |
| Polyols | 53.25 | 53.25 | 47.34 | 47.04 | 51.30 | 51.00 | 60.53 | 60.23 | 60.23 |
| Softener | 8.50 | 8.50 | 3.05 | 3.05 | 4.03 | 4.03 | 2.00 | 2.00 | 2.00 |
| Glycerol Monostearate | 0.34 | 0.34 | 1.14 | 1.14 | 1.09 | 1.09 | 1.49 | 1.49 | 1.49 |
| Lecithin | 0.56 | 0.56 | 0.40 | 0.40 | 0.47 | 0.47 | 0.80 | 0.80 | 0.80 |
| Acetylated Monoglycerides | 0.50 | 0.50 | 0.50 | 0.50 | 0.50 | 0.50 | 0.00 | 0.00 | 0.00 |
| Polyglycerol Esters of Fatty Acids (HLB 7.5) | 0.00 | 0.00 | 0.00 | 0.30 | 0.00 | 0.30 | 0.00 | 0.30 | 0.00 |
| Polyglycerol Esters of Fatty Acids (HLB 11) | 0.00 | 0.00 | 0.00 | 0.00 | 0.00 | 0.00 | 0.00 | 0.00 | 0.30 |
| SURFONIC ® L24-2 | 0.00 | 0.00 | 0.00 | 0.00 | 0.00 | 0.00 | 0.00 | 0.00 | 0.00 |
| SURFONIC ® L24-3 | 0.00 | 0.00 | 0.00 | 0.00 | 0.00 | 0.00 | 0.00 | 0.00 | 0.00 |
| SURFONIC ® L24-4 | 0.00 | 0.00 | 0.00 | 0.00 | 0.00 | 0.00 | 0.00 | 0.00 | 0.00 |
| SURFONIC ® L24-5 | 0.00 | 0.00 | 0.00 | 0.00 | 0.00 | 0.00 | 0.00 | 0.00 | 0.00 |
| SURFONIC ® L24-7 | 0.00 | 0.00 | 0.00 | 0.00 | 0.00 | 0.00 | 0.00 | 0.00 | 0.00 |
| SURFONIC ® L24-9 | 1.11 | 0.00 | 0.00 | 0.00 | 0.00 | 0.00 | 0.00 | 0.00 | 0.00 |
| SURFONIC ® L24-12 | 0.00 | 1.11 | 0.00 | 0.00 | 0.00 | 0.00 | 0.00 | 0.00 | 0.00 |
| Other Gum Base ingredients | 28.71 | 28.71 | 34.82 | 34.82 | 35.80 | 35.80 | 28.53 | 28.53 | 28.53 |
| Flavor | 3.41 | 3.41 | 2.81 | 2.81 | 2.81 | 2.81 | 3.96 | 3.96 | 3.96 |
| Sweeteners (free and encapsulated) | 3.51 | 3.51 | 3.84 | 3.84 | 4.00 | 4.00 | 1.87 | 1.87 | 1.87 |
| Acids (free and encapsulated) | 0.00 | 0.00 | 6.10 | 6.10 | 0.00 | 0.00 | 0.70 | 0.70 | 0.70 |
| Coloring | 0.11 | 0.11 | 0.00 | 0.00 | 0.00 | 0.00 | 0.12 | 0.12 | 0.12 |
| Total (%) | 100.00 | 100.00 | 100.00 | 100.00 | 100.00 | 100.00 | 100.00 | 100.00 | 100.00 |

TABLE 2
Table 2 Emulsifiers

| Trade Name | Chemical Name | HLB |
|---|---|---|
| | Glyceryl monostearate | 3.8 |
| | Lecithin | 4 |
| | Acetylated monoglycerides | 1.5 |
| | Polyglycerol esters of fatty acids | 7.5 |
| | Polyglycerol esters of fatty acids | 11 |
| SURFONIC ® L24-2 | 2 mole ethoxylate of linear C12-C14 | 6.2 |
| | alcohol | |
| SURFONIC ® L24-3 | 3 mole ethoxylate of linear C12-C14 | 8 |
| | alcohol | |
| SURFONIC ® L24-4 | 4 mole ethoxylate of linear C12-C14 | 9.4 |
| | alcohol | |
| SURFONIC ® L24-5 | 5 mole ethoxylate of linear C12-C14 | 10.6 |
| | alcohol | |
| SURFONIC ® L24-7 | 7 mole ethoxylate of linear C12-C14 | 11.9 |
| | alcohol | |
| SURFONIC ® L24-9 | 9 mole ethoxylate of linear C12-C14 | 12.9 |
| | alcohol | |
| SURFONIC ® L24-12 | 12 mole ethoxylate of linear C12-C14 | 14.4 |
| | alcohol | |

TABLE 3
Table 3. RWA HLB and AWA HLB

| Example | Emulsifiers | HLB | Weight % | RWAHLB | AWAHLB |
|---|---|---|---|---|---|
| C1 | Glyceryl Monostearate | 3.8 | 1.51 | 3.35 | 0.080 |
| | Lecithin | 4 | 0.38 | | |
| | Acetylated Monoglycerides | 1.5 | 0.50 | | |
| Ex 1 | Glyceryl Monostearate | 3.8 | 1.51 | 4.34 | 0.137 |
| | Lecithin | 4 | 0.38 | | |
| | Acetylated Monoglycerides | 1.5 | 0.50 | | |
| | Polyglycerol Esters of Fatty | 7.5 | 0.75 | | |
| | Acids | | | | |
| Ex 2 | Glyceryl Monostearate | 3.8 | 1.51 | 4.44 | 0.144 |
| | Lecithin | 4 | 0.38 | | |
| | Acetylated Monoglycerides | 1.5 | 0.50 | | |
| | Polyglycerol Esters of Fatty | 11 | 0.85 | | |
| | Acids | | | | |
| C2 | Glyceryl Monostearate | 3.8 | 1.45 | 3.20 | 0.080 |
| | Lecithin | 4 | 0.56 | | |
| | Acetylated Monoglycerides | 1.5 | 0.50 | | |
| Ex 3 | Glyceryl Monostearate | 3.8 | 0.34 | 5.94 | 0.149 |
| | Lecithin | 4 | 0.56 | | |
| | Acetylated Monoglycerides | 1.5 | 0.50 | | |
| | SURFONIC ® L24-2 | 6.2 | 1.11 | | |
| Ex 4 | Glyceryl Monostearate | 3.8 | 0.34 | 6.74 | 0.169 |
| | Lecithin | 4 | 0.56 | | |
| | Acetylated Monoglycerides | 1.5 | 0.50 | | |
| | SURFONIC ® L24-3 | 8 | 1.11 | | |
| Ex 5 | Glyceryl Monostearate | 3.8 | 0.34 | 7.36 | 0.185 |
| | Lecithin | 4 | 0.56 | | |
| | Acetylated Monoglycerides | 1.5 | 0.50 | | |
| | SURFONIC ® L24-4 | 9.4 | 1.11 | | |
| Ex 6 | Glyceryl Monostearate | 3.8 | 0.34 | 7.89 | 0.198 |
| | Lecithin | 4 | 0.56 | | |
| | Acetylated Monoglycerides | 1.5 | 0.50 | | |
| | SURFONIC ® L24-5 | 10.6 | 1.11 | | |
| Ex 7 | Glyceryl Monostearate | 3.8 | 0.34 | 8.47 | 0.212 |
| | Lecithin | 4 | 0.56 | | |
| | Acetylated Monoglycerides | 1.5 | 0.50 | | |
| | SURFONIC ® L24-7 | 11.9 | 1.11 | | |
| Ex 8 | Glyceryl Monostearate | 3.8 | 0.34 | 8.91 | 0.223 |
| | Lecithin | 4 | 0.56 | | |
| | Acetylated Monoglycerides | 1.5 | 0.50 | | |
| | SURFONIC ® L24-9 | 12.9 | 1.11 | | |
| Ex 9 | Glyceryl Monostearate | 3.8 | 0.34 | 9.57 | 0.240 |
| | Lecithin | 4 | 0.56 | | |
| | Acetylated Monoglycerides | 1.5 | 0.50 | | |
| | SURFONIC ® L24-12 | 14.4 | 1.11 | | |
| C3 | Glyceryl Monostearate | 3.8 | 1.14 | 3.95 | 0.080 |
| | Lecithin | 4 | 0.40 | | |
| | Acetylated Monoglycerides | 1.5 | 0.50 | | |
| Ex 10 | Glyceryl Monostearate | 3.8 | 1.14 | 4.41 | 0.103 |
| | Lecithin | 4 | 0.40 | | |
| | Acetylated Monoglycerides | 1.5 | 0.50 | | |
| | Polyglycerol Esters of Fatty | 7.5 | 0.30 | | |
| | Acids | | | | |
| C4 | Glyceryl Monostearate | 3.8 | 1.09 | 3.91 | 0.080 |
| | Lecithin | 4 | 0.47 | | |
| | Acetylated Monoglycerides | 1.5 | 0.50 | | |
| Ex 11 | Glyceryl Monostearate | 3.8 | 1.09 | 4.36 | 0.103 |
| | Lecithin | 4 | 0.47 | | |
| | Acetylated Monoglycerides | 1.5 | 0.50 | | |
| | Polyglycerol Esters of Fatty | 7.5 | 0.30 | | |
| | Acids | | | | |
| C5 | Glyceryl Monostearate | 3.8 | 1.49 | 3.50 | 0.080 |
| | Lecithin | 4 | 0.80 | | |
| Ex 12 | Glyceryl Monostearate | 3.8 | 1.49 | 3.96 | 0.103 |
| | Lecithin | 4 | 0.80 | | |
| | Polyglycerol Esters of Fatty | 7.5 | 0.30 | | |
| | Acids | | | | |
| Ex 13 | Glyceryl Monostearate | 3.8 | 1.49 | 5.64 | 0.146 |
| | Lecithin | 4 | 0.80 | | |
| | Polyglycerol Esters of Fatty | 11 | 0.30 | | |
| | Acids | | | | |

As can be seen from Table 3, Ex. 1-13 have RWA HLB and AWA HLB values within the ranges disclosed herein. These examples exhibited one or more following advantages relative to the comparative examples: increased moisture uptake (measurable by moisture content analysis and change in mass), increased bolus size (measurable by change in mass and/or volume), increased cooling and/or flavor perception (measurable by flavor release profile and/or quantitative descriptive analysis), higher pellet core hardness while maintaining gum softness (measurable by hardness measurement before and during chew), increased mouthwatering (measurable by quantitative descriptive analysis and/or moisture content analysis of the gum), increased softness during chew (measurable by hardness measurement), increased smoothness perception during chew (measurable by gum surface contact angle and/or extensibility measurement), less drying (measurable by moisture content analysis), and/or less squeaky (measurable by gum surface contact angle).

### Comparative Chewing Examples

Comparative chewing experiments were carried out using Individual piece weights (samples) ranged from 2.05 g to 2.14 g for the Control Batch (made from the formulation Comparative Example C1 as shown in Table 1), and from 1.98 g to 2.01 g for the Experimental Batch (made from the formulation Example Ex. 2 also as shown in Table 1). Percentages were calculated in the case of the smallest piece weight as well as the largest piece weight to provide absolute ranges.

Twenty blind samples (ten each) were chewed by volunteers who were uninformed of the project. Each sample was first weighed and then chewed for 5 minutes before placing in a weighing dish and weighed again. The difference between the starting piece weight and the final weight is recorded as a percentage of the initial weight as shown in the Tables 4 and 5 below.

The resulting data shows a clear difference between the C1 Control Batch and Ex. 2 Experimental Batch sets of samples in terms of their ability to absorb water/saliva. The resulting weights of the chewed Control Batch samples ranged from 0.93 to 1.08 g, which averages out over a set of ten samples to be from 47% to 49% of the initial piece weight. If starting piece weight was assumed to be the lowest measured piece weight of 2.05 g for all pieces, the final chewed piece weights were 49% of the initial. If initial piece weights were assumed to all be the largest measured piece weight of 2.14 g, the final chewed piece weights were 47% of the initial piece weight. Therefore we will consider the range of piece weights at the 5 minute mark to have decreased to 47%-49% of the initial piece weights for the C1 Control Batch samples.

The resulting weights of the chewed Ex. 2 Experimental Batch samples ranged from 1.30 g-1.60 g, which averages out over a set of ten samples to be from 71% to 72% of the initial piece weight. If starting piece weight was assumed to be the lowest measured piece weight of 1.98 g for all pieces, the final chewed piece weights were 72% of the initial. If initial piece weights were assumed to all be the largest measured piece weight of 2.01 g, the final chewed piece weights were 71% of the initial piece weight. Therefore we will consider the range of piece weights at the 5 minute mark to have decreased to 71%-72% of the initial piece weights for the Ex. 2 Experimental samples.

Accordingly, this comparative data shows that the chewed bolus of the Ex. 2 Experimental Batch samples clearly maintained much more of their weight for the 5 minute chewing duration than the C1 Control Batch samples. This maintained larger weight means that the bolus of the Ex. 2 Experimental Batch samples will have a better perception to the chewer in that the C1 Control Batch samples in that a larger chewing cud remains in the mouth during chewing.

Individual sample data is shown in the Tables 4 and 5 below:

TABLE 4
C1 CONTROL BATCH - piece weights
ranged from 2.05 g to 2.14 g

| | | Wt of | % of | % of |
|---|---|---|---|---|
| | | chewed | initial | initial |
| chewer | | bolus, grams | if 2.05 g | if 2.14 g |
| C1 CONTROL | | | | |
| BATCH | | | | |
| Chewer 1 | | 1.03 | 50% | 48% |
| Chewer 2 | | 0.97 | 47% | 45% |
| Chewer 3 | | 1.00 | 49% | 47% |
| Chewer 4 | | 0.93 | 45% | 43% |
| Chewer 5 | | 0.94 | 46% | 44% |
| Chewer 6 | | 1.08 | 53% | 50% |
| Chewer 7 | | 1.08 | 53% | 50% |
| Chewer 8 | | 1.00 | 49% | 47% |
| Chewer 9 | | 1.00 | 49% | 47% |
| Chewer 10 | | 1.02 | 50% | 48% |
| | TOTALS | | 491% | 469% |
| | NUMBER | | 49% | 47% |
| | AVERAGE | | | |

TABLE 5
Ex. 2 EXPERIMENTAL BATCH - piece weights
ranged from 1.98 g to 2.01 g

| | | Wt of | % of | % of |
|---|---|---|---|---|
| | | chewed | initial | initial |
| chewer | | bolus, grams | if 1.98 g | if 2.01 g |
| Ex. 2 EXPERI- | | | | |
| MENTAL BATCH | | | | |
| Chewer 1 | | 1.30 | 66% | 65% |
| Chewer 2 | | 1.42 | 72% | 71% |
| Chewer 3 | | 1.35 | 68% | 67% |
| Chewer 4 | | 1.41 | 71% | 70% |
| Chewer 5 | | 1.40 | 71% | 70% |
| Chewer 6 | | 1.34 | 68% | 67% |
| Chewer 7 | | 1.54 | 78% | 77% |
| Chewer 8 | | 1.60 | 81% | 80% |
| Chewer 9 | | 1.50 | 76% | 75% |
| Chewer 10 | | 1.43 | 72% | 71% |
| | TOTALS | | 723% | 713% |
| | NUMBER | | 72% | 71% |
| | AVERAGE | | | |

### Embodiment 1

A gum composition comprising: at least one emulsifier having a relative weighted average hydrophilic-lipophilic balance (RWA HLB) within a range of 3.9-12 and having an absolute weighted average HLB (AWA HLB) within a range of 0.10-0.25.

### Embodiment 2

The gum composition of Embodiment 1, wherein the at least one emulsifier comprises at least one selected from the group comprising: polyglycerol esters of fatty acids; 2 mole ethoxylate of linear C12-C14 alcohol; 3 mole ethoxylate of linear C12-C14 alcohol; 4 mole ethoxylate of linear C12-C14 alcohol; 5 mole ethoxylate of linear C12-C14 alcohol; 7 mole ethoxylate of linear C12-C14 alcohol; 9 mole ethoxylate of linear C12-C14 alcohol; and 12 mole ethoxylate of linear C12-C14 alcohol; lecithin; glyceryl monostearate; acetylated monoglycerides; oleic acid; acetylated monoglycerides; sorbitan trioleate; glycerol dioleate; sorbitan tristearate; propylene glycol monostearate; glycerol monooleate; glycerol monostearate; acetylated monoglycerides (stearate); sorbitan monooleate; propylene glycol monolaurate; sorbitan monostearate; calcium stearoxyl-2-lactylate; glycerol monolaurate; sorbitan monopalmitate; lecithin; diacetylated tartaric acid esters of monoglycerides; sodium stearoyl lactylate; sorbitan monolaurate; polyoxyethylene (20) sorbitan tristearate; polyoxyethylene (20) sorbitan trioleate; polyoxyethylene (20) sorbitan monostearate; sucrose monolaurate; polyoxyethylene (20) sorbitan monooleate; polyoxyethylene (20) sorbitan monopalmitate; and combinations thereof.

### Embodiment 3

The gum composition of Embodiment 2, wherein the at least one emulsifier comprises polyglycerol esters of fatty acids a HLB in the range of 7-12.

### Embodiment 4

The gum composition of any of Embodiments 1-3, wherein the RWA HLB is within the range of 4-6.

### Embodiment 5

The gum composition of Embodiment 4, wherein the AWA HLB is within the range of 0.13-0.18.

### Embodiment 6

The gum composition of Embodiment 4, wherein the AWA HLB is within the range of 0.11-0.20.

### Embodiment 7

The gum composition of Embodiment 4, wherein the AWA HLB is within the range of 0.12-0.20.

### Embodiment 8

The gum composition of any of Embodiments 1-3, wherein the AWA HLB is within the range of 0.13-0.18.

### Embodiment 9

The gum composition of any of Embodiments 1-3, wherein the AWA HLB is within the range of 0.11-0.20.

### Embodiment 10

The gum composition of any of Embodiments 1-3, wherein the AWA HLB is within the range of 0.12-0.20.

### Embodiment 11

The gum composition of Embodiment 1, wherein the gum composition comprises one emulsifier.

### Embodiment 12

A gum composition comprising: mixture of at least a first emulsifier and at least a second emulsifier, the mixture having a relative weighted average hydrophilic-lipophilic balance (RWA HLB) within a range of 3.9-12 and having an absolute weighted average HLB (AWA HLB) within a range of 0.10-0.25.

### Embodiment 13

The gum composition of Embodiment 12, wherein the at least first and the at least second emulsifiers each have a HLB within a range of 7-12.

### Embodiment 14

The gum composition of Embodiment 12, wherein the at least first emulsifier has a HLB within a range of 6-8 and the at least second emulsifier has a HLB within a range of 11-12.

### Embodiment 15

The gum composition of Embodiment 12, wherein the at least first and at least second emulsifiers comprise emulsifiers selected from the group comprising: polyglycerol esters of fatty acids; 2 mole ethoxylate of linear C12-C14 alcohol; 3 mole ethoxylate of linear C12-C14 alcohol; 4 mole ethoxylate of linear C12-C14 alcohol; 5 mole ethoxylate of linear C12-C14 alcohol; 7 mole ethoxylate of linear C12-C14 alcohol; 9 mole ethoxylate of linear C12-C14 alcohol; and 12 mole ethoxylate of linear C12-C14 alcohol; lecithin; glyceryl monostearate; acetylated monoglycerides; oleic acid; acetylated monoglycerides; sorbitan trioleate; glycerol dioleate; sorbitan tristearate; propylene glycol monostearate; glycerol monooleate; glycerol monostearate; acetylated monoglycerides (stearate); sorbitan monooleate; propylene glycol monolaurate; sorbitan monostearate; calcium stearoxyl-2-lactylate; glycerol monolaurate; sorbitan monopalmitate; lecithin; diacetylated tartaric acid esters of monoglycerides; sodium stearoyl lactylate; sorbitan monolaurate; polyoxyethylene (20) sorbitan tristearate; polyoxyethylene (20) sorbitan trioleate; polyoxyethylene (20) sorbitan monostearate; sucrose monolaurate; polyoxyethylene (20) sorbitan monooleate; polyoxyethylene (20) sorbitan monopalmitate; and combinations thereof.

### Embodiment 16

The gum composition of Embodiment 15, wherein at least one of the at least first and the at least second emulsifiers comprise polyglycerol esters of fatty acids a HLB in the range of 7-12.

### Embodiment 17

The gum composition of any of Embodiments 12-16, wherein the RWA HLB is within the range of 4-6.

### Embodiment 18

The gum composition of Embodiment 17, wherein the AWA HLB is within the range of 0.13-0.18.

### Embodiment 19

The gum composition of Embodiment 17, wherein the AWA HLB is within the range of 0.11-0.20.

### Embodiment 20

The gum composition of Embodiment 17, wherein the AWA HLB is within the range of 0.12-0.20.

### Embodiment 21

The gum composition of any of Embodiments 12-16, wherein the AWA HLB is within the range of 0.13-0.18.

### Embodiment 22

The gum composition of any of Embodiments 12-16, wherein the AWA HLB is within the range of 0.11-0.20.

### Embodiment 23

The gum composition of any of Embodiments 12-16, wherein the AWA HLB is within the range of 0.12-0.20.

### Embodiment 24

The gum composition of Embodiments 1 or 12, wherein the gum composition comprises three emulsifiers.

### Embodiment 25

A method of making a gum composition, comprising: providing at least one emulsifier having a relative weighted average hydrophilic-lipophilic balance (RWA HLB) within a range of 3.9-12 and having an absolute weighted average HLB (AWA HLB) within a range of 0.10-0.25 in a gum composition.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

The singular forms “a,” “an,” and “the” include plural referents unless the context clearly dictates otherwise.

The endpoints of all ranges directed to the same characteristic or component are independently combinable, and inclusive of the recited endpoint.

The term “combination” is inclusive of a homogenous or non-homogenous blend, mixture, or alloy of the named components into an integrated whole. The term “homogenous” refers to a uniform blend of the components.

The word “or” means “and/or.”

Providing can be accomplished by a manufacturer, distributor, or other seller that makes the product available to the consumer.

Instructing can be by means of packaging, package inserts, advertisements, web sites, and the like.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A gum composition comprising:
at least one emulsifier having a relative weighted average hydrophilic-lipophilic balance (RWA HLB) within a range of 3.9-12 and having an absolute weighted average HLB (AWA HLB) within a range of 0.10-0.25.

2. The gum composition of claim 1, wherein the at least one emulsifier comprises at least one selected from the group comprising: polyglycerol esters of fatty acids; 2 mole ethoxylate of linear C12-C14 alcohol; 3 mole ethoxylate of linear C12-C14 alcohol; 4 mole ethoxylate of linear C12-C14 alcohol; 5 mole ethoxylate of linear C12-C14 alcohol; 7 mole ethoxylate of linear C12-C14 alcohol; 9 mole ethoxylate of linear C12-C14 alcohol; and 12 mole ethoxylate of linear C12-C14 alcohol; lecithin; glyceryl monostearate; acetylated monoglycerides; oleic acid; acetylated monoglycerides; sorbitan trioleate; glycerol dioleate; sorbitan tristearate; propylene glycol monostearate; glycerol monooleate; glycerol monostearate; acetylated monoglycerides (stearate); sorbitan monooleate; propylene glycol monolaurate; sorbitan monostearate; calcium stearoxyl-2-lactylate; glycerol monolaurate; sorbitan monopalmitate; lecithin; diacetylated tartaric acid esters of monoglycerides; sodium stearoyl lactylate; sorbitan monolaurate; polyoxyethylene (20) sorbitan tristearate; polyoxyethylene (20) sorbitan trioleate; polyoxyethylene (20) sorbitan monostearate; sucrose monolaurate; polyoxyethylene (20) sorbitan monooleate; polyoxyethylene (20) sorbitan monopalmitate; and combinations thereof.

3. The gum composition of claim 2, wherein the at least one emulsifier comprises polyglycerol esters of fatty acids a HLB in the range of 7-12.

4. The gum composition of claim 1, wherein the RWA HLB is within the range of 4-6.

5. The gum composition of claim 4, wherein the AWA HLB is within the range of 0.13-0.18.

6. The gum composition of claim 4, wherein the AWA HLB is within the range of 0.11-0.20.

7. The gum composition of claim 4, wherein the AWA HLB is within the range of 0.12-0.20.

8. The gum composition of claim 1, wherein the AWA HLB is within the range of 0.13-0.18.

9. The gum composition of claim 1, wherein the AWA HLB is within the range of 0.11-0.20.

10. The gum composition of claim 1, wherein the AWA HLB is within the range of 0.12-0.20.

11. The gum composition of claim 1, wherein the gum composition comprises one emulsifier.

12. A gum composition comprising:
a mixture of at least a first emulsifier and at least a second emulsifier, the mixture having a relative weighted average hydrophilic-lipophilic balance (RWA HLB) within a range of 3.9-12 and having an absolute weighted average HLB (AWA HLB) within a range of 0.10-0.25.

13. The gum composition of claim 12, wherein the at least first and the at least second emulsifiers each have a HLB within a range of 7-12.

14. The gum composition of claim 12, wherein the at least first emulsifier has a HLB within a range of 6-8 and the at least second emulsifier has a HLB within a range of 11-12.

15. The gum composition of claim 12, wherein the at least first and at least second emulsifiers comprise emulsifiers selected from the group comprising: polyglycerol esters of fatty acids; 2 mole ethoxylate of linear C12-C14 alcohol; 3 mole ethoxylate of linear C12-C14 alcohol; 4 mole ethoxylate of linear C12-C14 alcohol; 5 mole ethoxylate of linear C12-C14 alcohol; 7 mole ethoxylate of linear C12-C14 alcohol; 9 mole ethoxylate of linear C12-C14 alcohol; and 12 mole ethoxylate of linear C12-C14 alcohol; lecithin; glyceryl monostearate; acetylated monoglycerides; oleic acid; acetylated monoglycerides; sorbitan trioleate; glycerol dioleate; sorbitan tristearate; propylene glycol monostearate; glycerol monooleate; glycerol monostearate; acetylated monoglycerides (stearate); sorbitan monooleate; propylene glycol monolaurate; sorbitan monostearate; calcium stearoxyl-2-lactylate; glycerol monolaurate; sorbitan monopalmitate; lecithin; diacetylated tartaric acid esters of monoglycerides; sodium stearoyl lactylate; sorbitan monolaurate; polyoxyethylene (20) sorbitan tristearate; polyoxyethylene (20) sorbitan trioleate; polyoxyethylene (20) sorbitan monostearate; sucrose monolaurate; polyoxyethylene (20) sorbitan monooleate; polyoxyethylene (20) sorbitan monopalmitate; and combinations thereof.

16. The gum composition of claim 15, wherein at least one of the at least first and the at least second emulsifiers comprise polyglycerol esters of fatty acids a HLB in the range of 7-12.

17. The gum composition of claim 12, wherein the RWA HLB is within the range of 4-6.

18. The gum composition of claim 17, wherein the AWA HLB is within the range of 0.13-0.18.

19. The gum composition of claim 17, wherein the AWA HLB is within the range of 0.11-0.20.

20. The gum composition of claim 17, wherein the AWA HLB is within the range of 0.12-0.20.

21. The gum composition of claim 12, wherein the AWA HLB is within the range of 0.13-0.18.

22. The gum composition of claim 12, wherein the AWA HLB is within the range of 0.11-0.20.

23. The gum composition of claim 12, wherein the AWA HLB is within the range of 0.12-0.20.

24. The gum composition of claim 1, wherein the gum composition comprises three emulsifiers.

25. A method of making a gum composition, comprising: providing at least one emulsifier having a relative weighted average hydrophilic-lipophilic balance (RWA HLB) within a range of 3.9-12 and having an absolute weighted average HLB (AWA HLB) within a range of 0.10-0.25 in a gum composition.
